(19) United States
(12) Patent Application Publication
(10) Pub. No.: US 2007/0272196 A1
(43) Pub. Date: Nov. 29, 2007

(54) Lubricating system for a vehicle power unit

(75) Inventors: Toru Nishi, Saitama (JP); Kazuaki Iino, Saitama (JP)

Correspondence Address: CARRIER BLACKMAN AND ASSOCIATES, 24101 NOVI ROAD, SUITE 100, NOVI, MI, 48375, US

(73) Assignee: Honda Motor Co., Ltd., Tokyo (JP)

(21) Appl. No.: 11/805,345

(22) Filed: May 23, 2007

(30) Foreign Application Priority Data
May 26, 2006 (JP) 2006-146730

(51) Int. Cl. F01M 1/02; F01M 1/04; F02B 75/32

(52) U.S. Cl. 123/196 R; 184/6.5; 123/197.1

(57) ABSTRACT

A lubricating system for a vehicle transmission is provided by which the transmission is effectively lubricated, without increasing the number of component parts. The transmission includes an input shaft, an intermediate shaft and an output shaft, each of which are contained in the inside of a power unit case. The intermediate shaft has with an axially extending oil passage that establishes communication between both opposed ends of the intermediate shaft such that one end of the intermediate shaft permits communication between the axial oil passage and a first oil passage formed in a first case half, and a second end of the intermediate shaft permits communication between the axial oil passage and a second oil passage formed in a second case half. The intermediate shaft also includes radial oil passages extending radially outward from the axial oil passage and opening in an outer peripheral surface thereof.

### CROSS-REFERENCE TO RELATED APPLICATIONS

The present invention claims priority under 35 USC 119 based on Japanese patent application No. 2006-146730, filed on May 26, 2006. The subject matter of this priority document is incorporated by reference herein.

### BACKGROUND OF THE INVENTION

1. Field of the Invention

The present invention relates to a lubricating system for a vehicle power unit, the power unit including an internal combustion engine and a transmission, the transmission modifying the rotational speed of the engine and transmitting the rotational driving force of the engine to vehicle wheels.

2. Description of the Background Art

Known vehicle transmissions include a plurality of gear trains which are selectively engagable and are disposed between an input shaft and an output shaft arranged in parallel to each other. In addition, in a power unit including an internal combustion engine and a transmission, in order to obtain stable operation of the internal combustion engine and the transmission, the vehicle power unit is provided with a lubricating system for supplying a lubricating oil to sliding motion portions of shafts and gears, meshing portions of gears, and the like. Such a lubricating system is disclosed, for example, in Japanese Patent Laid-open No. 2003-239715. In Japanese Patent Laid-open No. 2003-239715, a lubricating system is disclosed which has a strainer provided at an oil reservoir provided in a housing for the internal combustion engine and the transmission. In addition, a feed pump is disclosed which discharges the lubricating oil present in the oil reservoir, and the lubricating oil in the oil reservoir is supplied through the feed pump to portions of the vehicle power unit.

The lubricating system disclosed in Japanese Patent Laid-open No. 2003-239715 has oil passages extending in two directions, wherein one of the oil passages is provided in a cylinder block and a cylinder head so as to be connected to a valve operating mechanism, etc., and the other of the oil passages is provided in the housing for the transmission so as to be connected to the gears constituting the transmission, etc. In addition, the lubricating system is so configured that a pipe member, dedicated as forming a part of the other oil passage, is disposed in parallel to the two shafts to which the gears are attached, and the lubricating oil flowing inside the pipe member is jetted through a radially extending hole to the meshing portion of the gears.

According to the above described known lubricating system, the transmission can be effectively lubricated because the lubricating oil is jetted to the meshing portions of the gears, but, on the other hand, the dedicated pipe member is used exclusively to form the oil passage, so that the number of component parts is increased, resulting a complicated lubrication structure. In addition, it is necessary to secure a new space for disposing the dedicated pipe member in the inside of the housing accommodating the transmission, so that the transmission is enlarged in size, a condition which generally results in a worsened ability to mount the power unit onto the vehicle and an increased cost.

In view of these problems, it is an object of the present invention to provide a lubricating system for a vehicle by which a power unit including a transmission can be effectively lubricated, in which an increase in the number of component parts is not required.

### SUMMARY

In order to attain the above object, according to the present invention, there is provided a lubricating system for a vehicle power unit. The power unit includes an internal combustion engine and a transmission. The transmission is contained in the power unit case and operates to transmit a rotational driving force of the internal combustion engine at a modified speed to vehicle wheels. The lubricating system includes a feed pump provided in the vehicle power unit and driven by the internal combustion engine. The power unit case includes a first case half and a second case half coupled to each other, and the transmission is supplied with a lubricating oil discharged from the feed pump, through an oil passage formed in the transmission case. The transmission includes: an input shaft rotatably supported on the power unit case, coaxially supporting input-side gears, and being supplied with the rotational driving force of the internal combustion engine; an output shaft rotatably supported on the power unit case, coaxially supporting output-side gears meshed with the input-side gears, and outputting a rotational driving force to the wheels; and an intermediate shaft supported, in the state of being restricted in rotation, on the power unit case at a position adjacent to the input shaft and the output shaft, and coaxially supporting an idle gear. In addition, the intermediate shaft is provided with an axially aligned oil passage that extends between opposed ends thereof. Communication is provided between the respective opposed ends of the intermediate shaft and a radial oil passage extending radially outwards from the axial oil passage to open in an outer peripheral surface of the intermediate shaft. In addition, the axial oil passage communicates at a first end thereof with a first oil passage formed in the first case half, and communicates at a second end thereof with a second oil passage formed in the second case half.

The intermediate shaft is provided with a hole extending in a radial direction, and an anti-rotation member projecting radially outwards is fitted in the hole. The anti-rotation member is fitted in a lock groove formed in an inside wall surface of the power unit case when the intermediate shaft is supported on the power unit case, whereby rotation of the intermediate shaft is prevented. In addition, the idle gear on the intermediate shaft is a reverse idle gear meshed with the input-side gears and the output-side gears, and the intermediate shaft is disposed above the input shaft and the output shaft.

The output shaft is rotatably supported on the first case half at one end thereof, is rotatably supported on the second case half at the other end thereof, and is provided with an oil passage extending in the axial direction from the other end. The first oil passage establishes communication between a discharge port of the feed pump and the axial oil passage, and the second oil passage establishes communication between the axial oil passage in the intermediate shaft and the other end of the output shaft formed at the second case half. In addition, the radial oil passage in the intermediate shaft is disposed oppositely to the meshing part of the input-side gear and the output-side gear.

According to the lubricating system for a vehicle power unit of the present invention configured as above, the intermediate shaft, which constitutes a portion of the transmission, is supported on the bisected type power unit case, and the axial oil passage formed to establish communication between respective opposed ends of the intermediate shaft communicates with the oil passages formed in the first and second case halves. Therefore, communication between the oil passages in the halves of the power unit case can be established through the axial oil passage, and the lubricating oil can be jetted into the inside of the power unit case. By thus utilizing component members of the transmission for oil passages, a dedicated pipe member for exclusive use as a lubrication passageway, as adopted in the prior art, can be omitted, whereby reductions in size, weight and cost of a transmission are obtained.

In addition, when the intermediate shaft is borne on the power unit case while keeping the condition where a tip portion of the anti-rotation member projecting radially outwards from the intermediate shaft is fitted in the lock hole in the inside wall surface of the power unit case, the rotation of the intermediate shaft is accurately restricted with this simple structure, and the intermediate shaft is accurately positioned in the circumferential direction in relation to the power unit case. Therefore, when the direction in which the radial oil passage extends is preliminarily set accurately in relation to the direction in which the tip portion of the anti-rotation member projects, the direction and location of jetting of the lubricating oil through the radial oil passage can be easily set in the desired direction.

In addition, when the gear supported on the intermediate shaft is a reverse idle gear, a transmission capable of setting a reverse gear stage is configured in a reduced size and weight relative to known transmissions.

Moreover, with the configuration in which the first oil passage establishes communication between the discharge port of the feed pump and one end of the axial oil passage in the intermediate shaft, and the second oil passage establishes communication between the other end of the axial oil passage in the intermediate shaft and the other end of the output shaft which is borne on the second case half and which communicates with an axially extending oil passage, the intermediate shaft is disposed on the upstream side and the output shaft is disposed on the downstream side. Thus, in accordance with the configuration in which the intermediate shaft designed to jet the lubricating oil through the radial oil passage is set on the upstream side, a high oil pressure is effectively utilized.

By setting the radial oil passage in the intermediate shaft oppositely to the meshing parts of the input-side gears and the output-side gears, a stable operation of the transmission is obtained.

Modes for carrying out the present invention are explained below by reference to an embodiment of the present invention shown in the attached drawings. The above-mentioned object, other objects, characteristics and advantages of the present invention will become apparent form the detailed description of the embodiment of the invention presented below in conjunction with the attached drawings.

### BRIEF DESCRIPTION OF THE DRAWINGS

FIG. 1 is a left side sectional view of a power unit provided with the lubricating system for a vehicle according to the present invention, showing an internal combustion engine at a front side of the power unit, and a transmission disposed within the power unit housing at a rear side of the engine.

FIG. 2 is a sectional view of the power unit of FIG. 1 taken along line II-II of FIG. 1 and viewed in the direction of the line arrows.

FIG. 3 is a sectional view of the power unit of FIG. 1 taken along line III-III of FIG. 1 and viewed in the direction of the line arrows.

FIG. 4 is a sectional view of the power unit of FIG. 1 taken along line IV-IV of FIG. 1 and viewed in the direction of the line arrows.

FIG. 5 is a sectional view of the power unit of FIG. 1 taken along line VI-VI of FIG. 1 and viewed in the direction of the line arrows.

FIG. 6 is a side sectional view of a portion of the right case of the power unit of FIG. 1, showing a strainer and a reverse inhibitor mechanism.

FIG. 7 is a right side view of the right case of the power unit of FIG. 1.

FIG. 8 is a left side view of the right case of the power unit of FIG. 1.

FIG. 9 is a right side view of a left case of the power unit of FIG. 1.

FIG. 10 is a left side view of the left case of the power unit of FIG. 1.

FIG. 11 is a right side view of the right case of the power unit of FIG. 1, fitted with a right cover, a clutch cover and a pump cover.

FIG. 12(a) is a bottom view of the strainer used in the power unit of FIG. 1.

FIG. 12(b) is a side view of the strainer of FIG. 12(a).

FIG. 12(c) is a sectional view of the strainer taken along line C-C of FIG. 12(a).

FIG. 13 is a sectional view of the reverse idle shaft taken along line XIV-XIV of FIG. 4 and viewed in the direction of the line arrows.

FIG. 14 is a sectional view of a portion of the power unit, showing oil passages connected to a scavenging pump.

### DETAILED DESCRIPTION

A selected illustrative embodiment of the invention will now be described in some detail, with reference to the drawings. It should be understood that only structures considered necessary for clarifying the present invention are described herein. Other conventional structures, and those of ancillary and auxiliary components of the system, are assumed to be known and understood by those skilled in the art. In the drawings, the directions of arrow U and arrow F indicate the upper side and the front side, respectively.

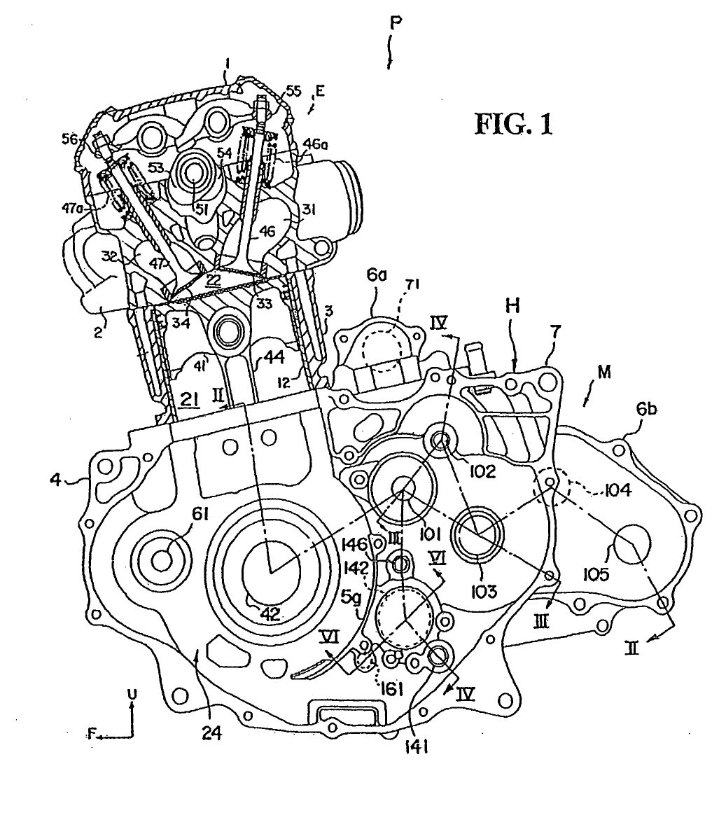

FIG. 1 shows a left side sectional view of a power unit P of a saddle-ride type vehicle provided with a lubricating system according to the present invention. Incidentally, a saddle-ride type vehicle refers to a vehicle on which a rider/operator straddles the vehicle during operation. Examples of the saddle-ride type vehicle include, but are not limited to, an all-terrain vehicle, a motorcycle, a jet ski, and the like. The power unit P consists of a single-cylinder 4-stroke-cycle type engine E and a transmission M for transmitting a rotational driving force of the engine to rear wheels (not shown).

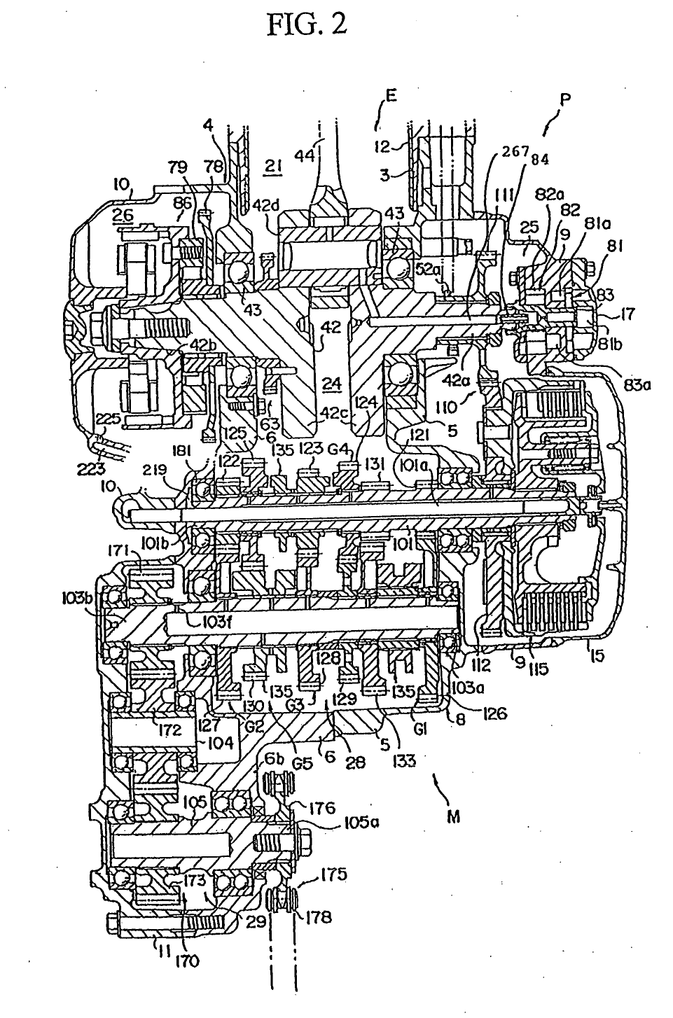

As shown in FIGS. 1 and 2, the engine E has a crankcase 4 accommodating a crankshaft 42 in an inside space (crank chamber 24) thereof while rotatably bearing the crankshaft 42 on left and right side surfaces of the crankcase 4. A cylinder block 3 is connected to the upper side of the crankcase 4, with a piston 41 axially slidably inserted in a hollow cylindrical cylinder bore 21 formed therein. A cylinder head 2 covers the upper side of the cylinder bore 21 and is connected to the cylinder block 3, and a head cover 1 covers, and is attached to, the upper side of the cylinder head 2. The cylinder bore 21 is formed in the state of being surrounded by the inner peripheral surface of a sleeve 12 fitted in the inside of the cylinder block 3. The crank chamber 24 accommodates left and right crank webs 42c, 42c of the crankshaft 42 and a crank pin 42d. The cylinder bore 21 and the crank chamber 24 communicate with each other, and the piston 41 and the crankshaft 42 are connected to each other through a connecting rod 44.

In addition, a combustion chamber 22 is formed in the state of being surrounded by the cylinder head 2, the sleeve 12 and the piston 41. The combustion chamber 22 communicates with an intake port 31 and an exhaust port 32 formed inside the cylinder head 2, through an intake aperture 33 and an exhaust aperture 34. An intake valve 46 and an exhaust valve 47 mounted to the cylinder head 2 are biased by valve springs 46a and 47a in the directions for closing the intake and exhaust apertures 33 and 34, respectively. A camshaft 51, provided with cams 53 and 54 on an outer peripheral surface thereof, is rotatably borne on the respective joined surfaces of the head cover 1 and the cylinder head 2. Rocker arms 55 and 56, abutting on the cams 53 and 54 of the camshaft 51 at one-side ends thereof and abutting on the upper ends of the intake and exhaust valves 46 and 47 at the other-side ends thereof, are pivotably provided in the inside of the head cover 1. The rotation of the crankshaft 42 is transmitted to the camshaft 51 through a chain. When the camshaft 51 is rotated, the rocker arms 55, 56 are pivoted at predetermined times under the actions of the cams 53 and 54, whereby the intake and exhaust valves 46 and 47 are moved downward against the biasing forces of the valve springs 46a and 47a, to open the intake and exhaust apertures 33 and 34, respectively.

An intake pipe (not shown) communicating with the exterior is connected to the intake port 31. A throttle valve for controlling the intake amount, an injector for injecting a fuel, and an air cleaner for cleaning the outside air are attached to the intake pipe. With the piston 41 moved downwards, the air cleaned by the air cleaner and the fuel injected from the injector are mixed with each other, and the fuel-air mixture in an amount according to the opening of the throttle valve is fed through the intake port 31 and the intake aperture 33 into the combustion chamber 22. The mixture is compressed attendant on an upward movement of the piston 41, is then ignited by a spark plug (not shown) attached to the cylinder head 2, to be combusted, whereby the piston 41 is again moved downwards. The gas formed upon the combustion is discharged to the exterior through the exhaust aperture 34, the exhaust port 32 and an exhaust pipe (not shown) connected to the exhaust port 32 when the piston 41 is again moved upwards. While the series of intake, compression, combustion and exhaust strokes are repeated, the piston 41 is reciprocated and the crankshaft 42 is rotated.

The crankcase 4 is split to the left and right sides, and has a right case 5 and a left case 6 coupled to each other. A right cover 9 is mounted on the right case 5 so as to cover a part of the right side surface of the right case 5, and a left cover 10 is mounted on the left case 6 so as to cover a front part of the left side surface of the left case 6.

A right end portion 42a of the crankshaft 42 is contained in the inside (a right accessory chamber 25) of the right cover 9, and a cam drive sprocket 52a constituting a chain power transmission mechanism for transmitting power to the camshaft 51 and a primary drive gear 111 of the transmission M are connected to the right end portion 42a. In addition, a drive shaft 83 of an oil pump (a feed pump 81 and a scavenging pump 82) is connected to the right end of the crankshaft 42.

A left end portion 42b of the crankshaft 42 is contained in the inside (a left accessory chamber 26) of the left cover 10, a generator 86 is provided at the left end portion 42b, and a starter driven gear 78 for starting the crankshaft 42 is connected to the left end portion 42b through a one-way clutch 79. A rotational driving force of a starter motor 71, which is mounted to a motor mounting bracket 6a extending upward integrally from the left case 6, is transmitted to the starter driven gear 78.

In addition, as shown in FIG. 1, a balancer shaft 61 is located on the front side of the crankshaft 42. The balancer shaft 61 functions as a primary balancer shaft, and is contained in the crank chamber 24. A balancer drive gear 63a, constituting a gear train 63 for rotating the balancer shaft 61 synchronously with the crankshaft 42, is provided on the crankshaft 42, in contact with a crank web 42c on the left side.

As shown in FIGS. 1 to 4, the transmission M on one side is provided in the inside (a transmission chamber 28) and the outside of a transmission case 8 formed as one body with a rear portion of the crankcase 4. The transmission M consists of a transmission mechanism 120 having a main shaft 101, a reverse idle shaft 102, a counter shaft 103, a final idle shaft 104 and an output shaft 105 which are provided in parallel to the crankshaft 42, a primary gear train 110 provided between the crankshaft 42 and the main shaft 101, and a plurality of transmission gear trains G1 to G5, GR which are provided between the main shaft 101 and the counter shaft 103. In addition, the transmission M consists of a final gear train 170 provided between the counter shaft 103 and the output shaft 105, and a chain drive mechanism 175 provided between the output shaft 105 and rear wheels.

As shown in FIG. 1, the five shafts 101 to 105 are arrayed in the order of the numerals from the front side of the transmission M, and are all disposed above the crankshaft 42. In addition, the main shaft 101 is disposed on the rear upper side of the crankshaft 42, and the counter shaft 103 is disposed on the rear lower side of the main shaft 101. The reverse idle shaft 102 is disposed between the main shaft 101 and the counter shaft 103 in the front-rear direction, above both the shafts 101, 103. In addition, the counter shaft 103 and the output shaft 105 are arrayed in the front-rear direction so that a straight line connecting their axes extends substantially horizontally. The final idle shaft 104 is disposed between both these shafts 103 and 105 in the front-rear direction, above both the shafts 103, 105.

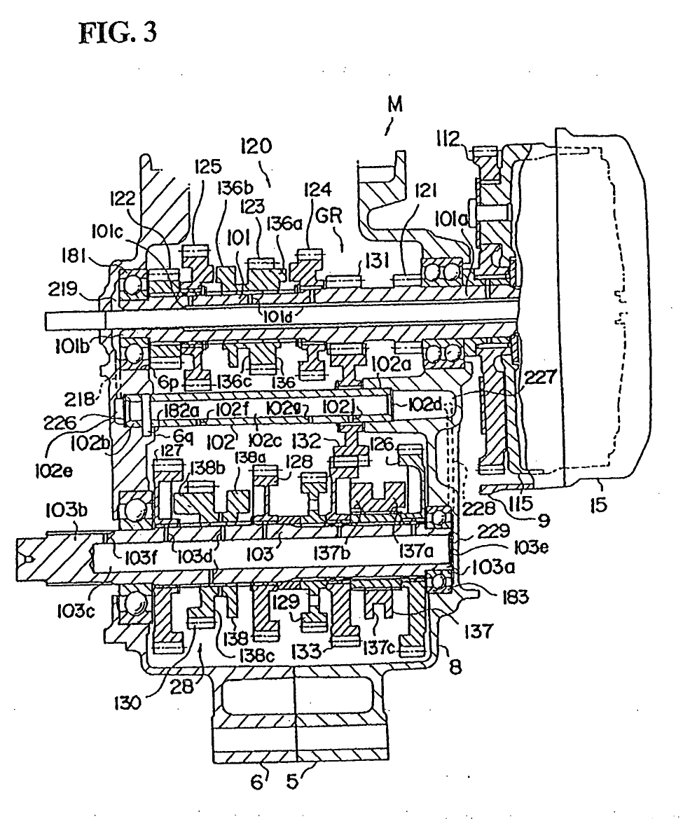

As shown in FIG. 3, the main shaft 101, the reverse idle shaft 102 and the counter shaft 103 are contained in the transmission chamber 28 so that each of these shafts 101, 102, 103 are borne on the transmission case 8 (i.e., the right case 5 and the left case 6) at respective end portions thereof. It should be noted that the main shaft 101 and the counter shaft 103 are rotatably borne, while the reverse idle shaft 102 is a fixed shaft.

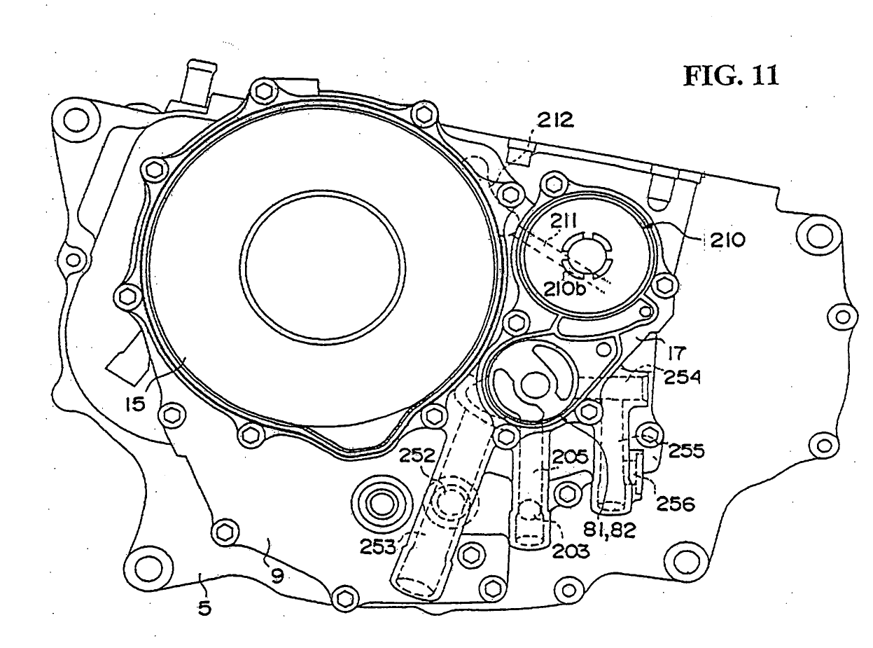

As shown in FIG. 2, a right end portion 101a of the main shaft 101 is contained in the right accessory chamber 25. The primary gear train 110 consists of the primary drive gear 111, and a primary driven gear 112 provided at the right end portion 101a of the main shaft 101 so as to rotate relative to the main shaft 101. The primary driven gear 112 is meshed with the primary drive gear 111. A clutch mechanism 115 for engaging and disengaging the primary driven gear 112 with and from the main shaft 101 is provided at the right end of the main shaft 101. The right cover 9 is open at its portion covering the clutch mechanism 115, and a clutch cover 15 is provided which covers the opened portion (see FIG. 11).

The transmission gear train consists of 1st to 5th speed gear trains G1 to G5 which permit forward operation, and which are provided between the main shaft 101 and the counter shaft 103 as shown in FIG. 2. The transmission gear train further consists of a reverse gear train GR which permits reverse operation, and which is provided between the main shaft 101 and the counter shaft 103 by way of the reverse idle shaft 102 as shown in FIG. 3. The gear trains G1 to G5, GR are set at different gear ratios, and one of gears constituting each gear train is relatively rotatably provided on the shaft.

The transmission mechanism 120 shown in FIGS. 2 to 4 is a normally gear meshed type transmission mechanism consisted of the six transmission gear trains G1 to G5, GR, a dog clutch mechanism 135 and a shift change mechanism 140, is capable of setting five forward gear stages and one reverse gear stage, and is contained in the transmission chamber 28. The transmission mechanism 120 is so configured that the dog clutch mechanism 135 is operated according to the operation of the shift change mechanism 140 operated by the driver, and one of the transmission gear trains G1 to G5, GR is rotated as one body with the main shaft 101 and the counter shaft 103. This ensures that the rotation of the main shaft 101 is transmitted to the counter shaft 103 through speed change, according to the gear ratio of the gear train capable of being rotated as one body with the shaft 101, 103.

As shown in FIGS. 1 and 2, a gear bracket 6b projecting rearwards is provided as one body with a rear portion of the left case 6, and a gear case 11 is mounted in the state of covering a rear portion of a left side surface of the left case 6 and a left side surface of the gear bracket 6b. A left end portion 103a of the counter shaft 103 is contained in a final gear chamber 29 formed inside the gear case 11 in the state of projecting from the left case 6. In addition, the final idle shaft 104 and the output shaft 105 are each contained in the final gear chamber 29, with a right end portion thereof borne on the gear bracket 6b and with a left end portion thereof borne on the gear case 11.

The final gear train 170 consists of a final drive gear 171 provided at a left end portion 103b of the counter shaft 103, a final idle gear 172 provided on the final idle shaft 104 and meshed with the final drive gear 171, and a final driven gear 173 provided on the output shaft 105 and meshed with the final idle gear 172. In addition, as shown in FIG. 2, a right end portion 105a of the output shaft 105 projects to the right side of the gear bracket 6b and is exposed to the exterior of the transmission case 8. The chain drive mechanism 175 includes a drive sprocket 176 connected to the right end portion 105a of the output shaft 105, a driven sprocket (not shown) connected to the rear wheel, and a drive chain wrapped around both the sprockets, and is disposed on the rear side of the transmission case 8.

In the transmission M, the rotation of the crankshaft 42 is transmitted through the primary gear train 110 and the main clutch 115 to the main shaft 101, the rotation of the main shaft 101 is transmitted through one of the transmission gear trains to the counter shaft 103, the rotation of the counter shaft 103 is transmitted through the final gear train 170 to the output shaft 105, and the rotation of the output shaft 105 is transmitted through the chain drive mechanism 175 to the rear wheel.

The transmission mechanism 120 will be described referring to FIGS. 2 to 4. As shown in FIG. 2, the 1st to 5th speed gear trains G1 to G5 are arranged in the order of the 1st speed gear train G1, the 4th speed gear train G4, the 3rd speed gear train G3, the 5th speed gear train G5, and the 2nd speed gear train G2, from the right side of the transmission. The gear trains G1 to G5 consist of drive gears 121 to 125 provided on the main shaft 101, and driven gears 126 to 130 provided on the counter shaft 103 and meshed with the corresponding drive gears 121-125 respectively. Of the gear trains G0 to G5, the gears 121, 122, 123, 129 and 130 are normally integrally rotatable with the shafts 101, 103, whereas the gears 126, 127, 128, 124, 125 are rotatable relative to the shafts 101, 103.

In addition, as shown in FIG. 3, the reverse gear train GR is disposed between the 1st speed and 4th speed gear trains G1 and G4 in the left-right direction, and consists of a reverse drive gear 131 integral with the main shaft 101, a reverse idle gear 132 relatively rotatably provided on the reverse idle shaft 102 and meshed with the reverse drive gear 131, and a reverse driven gear 133 relatively rotatably provided on the counter shaft 103 and meshed with the reverse idle gear 132.

The dog clutch mechanism 135 shown in FIGS. 2 and 3 consists of a first shift sleeve 136 formed as one body with the 3rd drive gear 123 and movable in the axial direction between the 4th and 5th speed drive gears 124 and 125. In addition, the dog clutch mechanism 135 includes a second shift sleeve 137 movable in the axial direction between the 1st speed and reverse driven gears 126 and 133 and rotated as one body with the counter shaft 103, and a third shift sleeve 138 formed as one body with the 5th speed driven gear 130 and movable in the axial direction between the 2nd and 3rd speed driven gears 127 and 128. FIGS. 2 and 3 show the condition where the 1 st to 3rd shift sleeves 136 to 138 are at neutral positions. The shift sleeves 136 to 138 are provided with dog teeth 136a to 138a, 136b to 138b projecting to the left and right sides. The gears (gears provided to be relatively rotatable) 126, 127, 128, 124, 125, 133 adjacent to the shift sleeves 136 to 138 are provided, in their surfaces facing the shift sleeves, with engaging holes for engagement with the dog teeth. The shift sleeves 136 to 138 are provided, in their central portions in the left-right direction, with fork grooves 136c to 138c for engagement with tip portions 143a to 145a of shift forks 143 to 145.

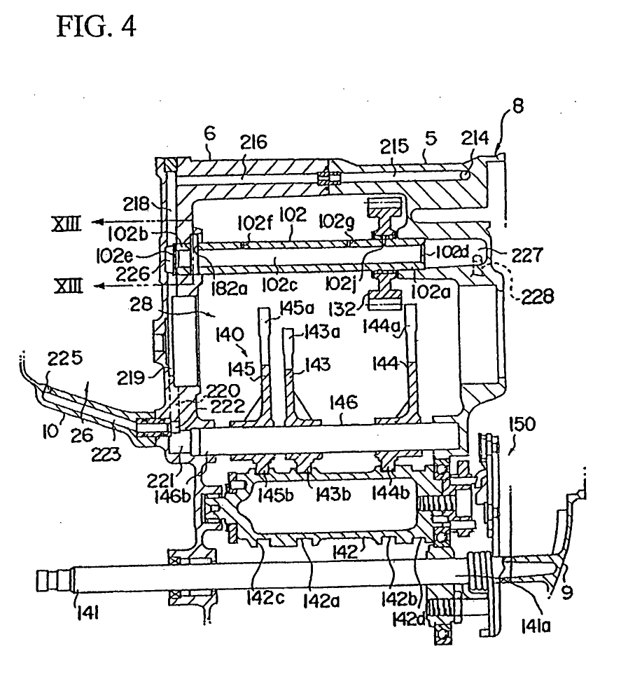

The shift change mechanism 140 shown in FIGS. 1 and 4 consists of a shift spindle 141 that rotates according to a pedal operation, and a shift drum 142 connected to the shift spindle 141 through an interlocking mechanism 150 and rotated by a predetermined angle at a time attendantly on the rotation of the shift spindle 141. The shift change mechanism 140 further includes the first to third shift forks 143 to 145 engaged with three cam grooves 142a to 142c formed in an outer peripheral surface of the shift drum 142, and a fork shaft 146 supporting the first to third shift forks 143 to 145.

The shift spindle 141, the shift drum 142 and the fork shaft 146 are contained in a lower portion of the transmission chamber 28, with respective opposed ends of each member 141, 142, 146 supported on the transmission case 8. The shift spindle 141 and the shift drum 142 are rotatably supported, and the fork shaft 146 is a fixed shaft. A right end portion 141a of the shift spindle 141 is contained in the right accessory chamber 25, and the interlocking mechanism 150 is linked to the right end portion 141a. In addition, the first shift fork 143 has a tip portion 143a engaged with the fork groove 136c of the first shift sleeve 136, and has a base end portion 143b engaged with the first cam groove 142a. The second shift fork 144 has a tip portion 144a engaged with the fork groove 137c of the second shift sleeve 137, and has a base end portion 144b engaged with the second cam groove 142b, and the third shift fork 145 has a tip portion 145a engaged with the fork groove 138c of the third shift fork 138, and has a base end portion 145b engaged with the third cam groove 142c.

In accordance with the dog clutch mechanism 135 and the shift change mechanism 140 configured as described as above, the shift drum 142 is rotated in a predetermined rotating direction by a predetermined angle at a time corresponding to the rotation of the shift spindle 141 according to a pedal operation. Consequently, the first to third shift forks 143 to 145 are moved in the axial direction of the fork shaft 146 while being guided by the cam grooves 142a to 142c. With the shift fork 143 to 145 moved, the corresponding shift sleeve 136 to 138 is moved in the axial direction of the main shaft 101 or the counter shaft 102. As a result, a speed change stage according to the pedal operation is set, as follows.

When all the first to third shift sleeves 136 to 138 are located in their neutral positions, a neutral stage in which the power transmission from the main shaft 101 to the counter shaft 103 is interrupted is set. When the pedal is operated to the up-shift side starting from this neutral condition, the shift drum 142 is rotated by a predetermined angle as indicated by arrow R1 in FIG. 6, whereby the second shift sleeve 137 is first moved rightwards, to set the 1st speed stage where the 1st speed driven gear 126 can be rotated as one body with the counter shaft 103 and power is transmitted through the 1st speed gear train G1. With a similar operation repeated, the third shift sleeve 138 is moved leftwards, to set the 2nd speed stage where the 2nd speed driven gear 127 can be rotated as one body with the counter shaft 103 and power is transmitted through the 2nd speed gear train G2; the third shift sleeve 138 is moved rightwards, to set the 3rd speed stage where the 3rd speed driven gear 128 can be rotated as one body with the counter shaft 103 and power is transmitted through the 3rd speed gear train G3; the first shift sleeve 136 is moved rightwards, to set the 4th speed stage where the 4th speed drive gear 124 can be rotated as one body with the main shaft 101 and power is transmitted through the 4th speed gear train G4; and the first shift sleeve 136 is moved leftwards, to set the 5th speed stage where the 5th speed drive gear 125 can be rotated as one body with the main shaft 101 and power is transmitted through the 5th speed gear train G5.

In addition, when a reverse arm (not shown) provided at a steering handle of the vehicle is operated, an inhibitor mechanism 160, shown in FIG. 6 and described below, is canceled. Further, when a predetermined pedal operation is made starting from the condition where the neutral stage is set, the shift drum 142 is rotated in the direction opposite to the rotating direction to the up-shift side, and the second shift sleeve 137 is moved rightwards, to set the reverse stage where the reverse driven gear 133 can be rotated as one body with the counter shaft 103 and power is transmitted through the reverse gear train GR.

In the setting of each speed change stage, the two shift sleeves of which the description has been omitted are returned into their neutral position or maintained in the neutral position.

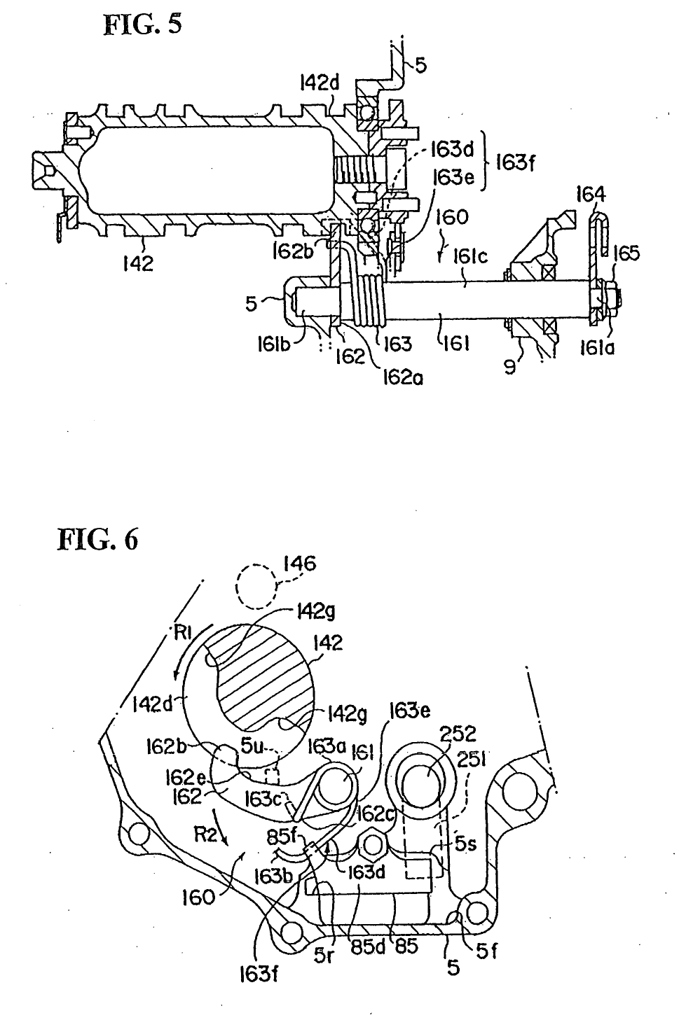

As shown in FIGS. 5 and 6, the transmission mechanism 120 is provided with a reverse inhibitor mechanism 160 which prevents non-intentional setting of the reverse stage by restricting the rotation of the shift drum 142 of the shift change mechanism 140. The reverse inhibitor mechanism 160 consists of a rotatable inhibitor shaft 161, an inhibitor arm 162 attached to and rotatable as one body with the inhibitor shaft 161 so as to rotate according to the rotation of the inhibitor shaft 161, and a torsion coil spring 163 which exerts a biasing force on the inhibitor arm 162.

The shift drum 142 is provided with an inhibitor groove 142d extending in the circumferential direction in the outer peripheral surface. A stopper 142g which projects radially outwards is formed in the inside of the inhibitor groove 142d. The inhibitor arm 162 is biased by the torsion coil spring 163 so as to locate a tip portion 162b thereof in the inside of the inhibitor groove 142d.

The inhibitor shaft 161 is a stepped shaft wherein a right end portion 161a and a left end portion 161b are smaller in diameter than a central portion 161c. A base end portion 162a of the inhibitor arm 162 provided with a through-hole is fitted over the left end portion 161b of the inhibitor shaft 161, the right end face of the inhibitor arm 162 is welded in abutment on the left end face of the central portion 161c, whereby the inhibitor arm 162 is rotated as one body with the inhibitor shaft 161. The inhibitor shaft 161 has its central portion 161c borne on the right cover 9, has its left end portion 161b borne on the right side surface of the right case 5, and has its right end portion 161a exposed to the outside of a housing H which will be described later.

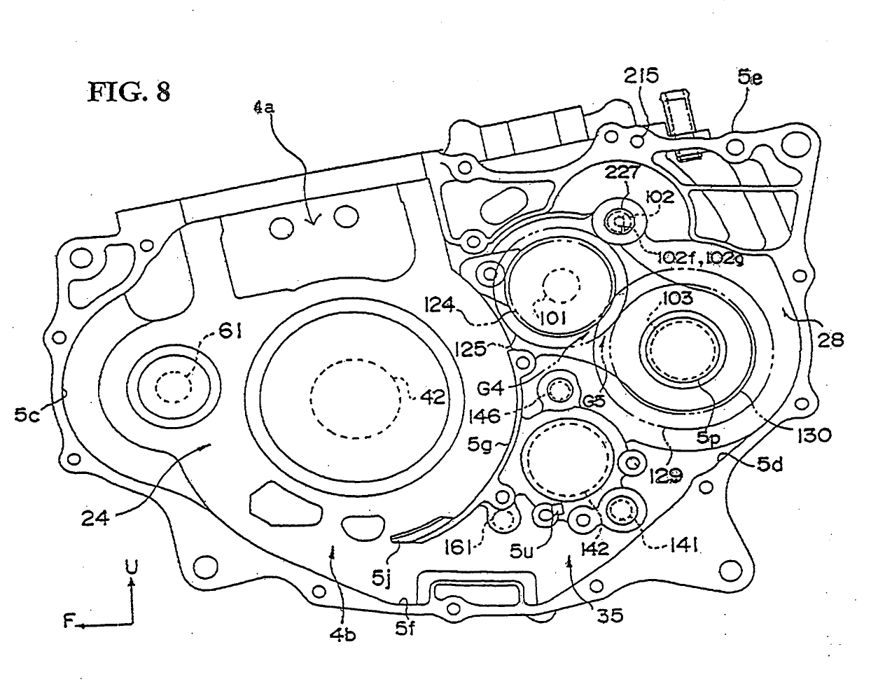

A coil portion 163a of the torsion coil spring 163 is fitted over the central portion 161c of the inhibitor shaft 161 contained in the right accessory chamber 25. One end portion 163b extending from the coil portion 163a of the torsion coil spring 163 is locked between the right case 5 and a strainer 85 which will be described later, and the other end portion 163c extending from the coil portion 163a is locked in a lock groove 162c in the inhibitor arm 162. With both the end portions 163b and 163c thus locked, the tip portion 162b of the inhibitor arm 162 is biased into the inhibitor groove 142d. In this case, the inhibitor arm 162 abuts on a stopper part 5u projecting on the inside wall surface of the right case (see FIG. 8), whereby the rotation of the inhibitor arm 162 by the biasing force of the torsion coil spring is restricted, the tip portion 162b of the inhibitor arm 162 is prevented from abutting on the shift drum, and the rotation of the shift drum is made smooth.

As shown in FIG. 6, a right end portion 161a of the inhibitor shaft 161 is partly cut away, and is provided with a male screw at the tip thereof. A reverse change arm 164 is fitted over the right end portion 161a, and then a nut 165 is screw-engaged with the right end portion 161a. The reverse change arm 164, fixed in this manner to the right end portion 161a of the inhibitor shaft 161, rotates interlockedly with the operation of a reverse lever (not shown).

The reverse inhibitor mechanism 160 is so configured that when the reverse lever is not operated and the reverse change arm 164 is in the normal position, the tip portion 162b of the inhibitor arm 162 is located in the inside of the inhibitor groove 142d. Therefore, even if the shift drum 142 is about to rotate in such a direction as to set the reverse stage, the tip portion 162b of the inhibitor arm 162 abuts on the stopper 142g provided in the inside of the inhibitor groove 142d, whereby rotation of the shift drum 142 is restrained. When the reverse lever is operated, the reverse change arm 164 is rotated. Since the reverse change arm 164 is fixed to the right end portion 161a, the inhibitor shaft 161 is securely rotated corresponding to the rotation of the reverse change arm 164. When the inhibitor shaft 161 is rotated interlockedly, the inhibitor arm 162 is swung in the direction of arrow R2 shown in FIG. 6, and the tip portion 162b is retracted to the outside of the inhibitor groove 142d. As a result, the shift drum 142 is permitted to rotate in such a direction as to set the reverse stage. Thereafter, with the operation of the reverse lever cleared, the inhibitor arm 162 is swung to a rotation restrictive position by the biasing force of the torsion coil spring 163, thereby returning again to the condition where the rotation of the shift drum 142 can be restrained by the inhibitor arm 162.

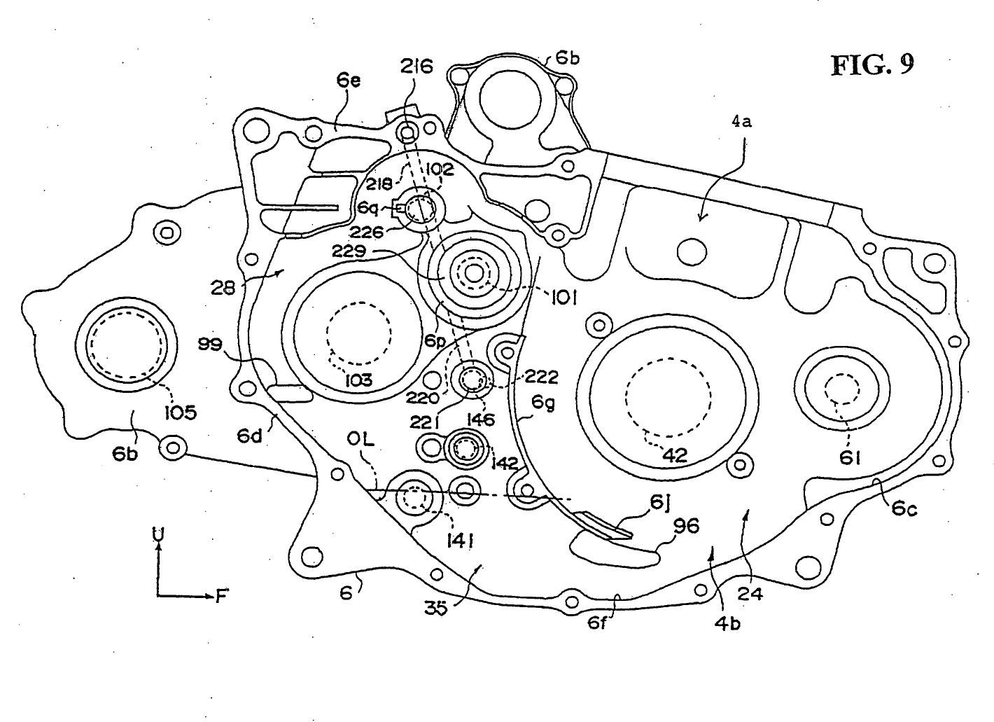

The housing structure of the power unit will now be described referring to FIGS. 1 and 7 to 11. The housing H of the power unit P includes the head cover 1, the cylinder head 2, the cylinder block 3, the right case 5, the left case 6, the right cover 9, the left cover 10 and the gear case 11, and further includes a clutch cover 15 and a pump cover 17 mounted from the right side so as to cover the open portion of the right cover 9. In addition, with the right case 5 and the left case 6 coupled, the crankcase 4 and the transmission case 8 having front wall portions 5c, 6c and rear wall portions 5d, 6d extending substantially vertically and upper wall portions 5e, 6e and lower wall portions 5f, 6f extending substantially in the front-rear direction are integrally formed on the front and rear sides. The crankcase 4 and the transmission case 8 (the crank chamber 24 and the transmission chamber 28) are partitioned to the front and rear sides by arcuate central partition walls 5g, 6g (see FIGS. 8 and 9) disposed along the rotational loci of crank webs 42c, 42c.

An oil reservoir chamber 35 surrounded by lower portions of the rear wall portions 5d, 6d and the lower wall portions 5e, 6e and serving for reserving the lubricating oil is formed on the lower side of the transmission chamber 28. An oil level OL at the time of operation on a horizontal surface is indicated by two-dotted chain line in FIG. 9. The oil reservoir chamber 35 communicates with the transmission chamber 28 in the vertical direction, and communicates also with the crank chamber 24 through a communicating space 4b on the front side of the lower ends of the central partition walls 5g, 6g.

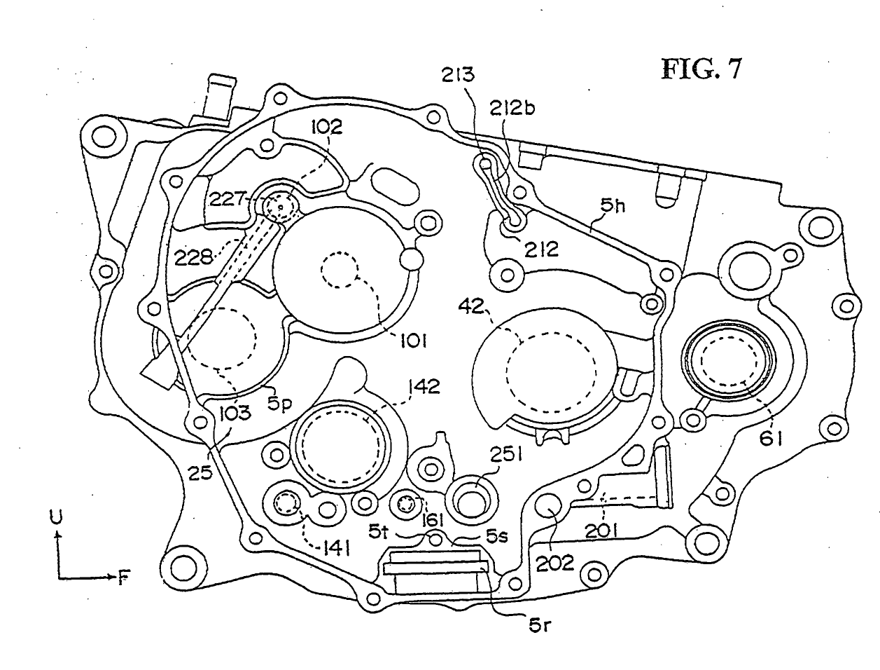

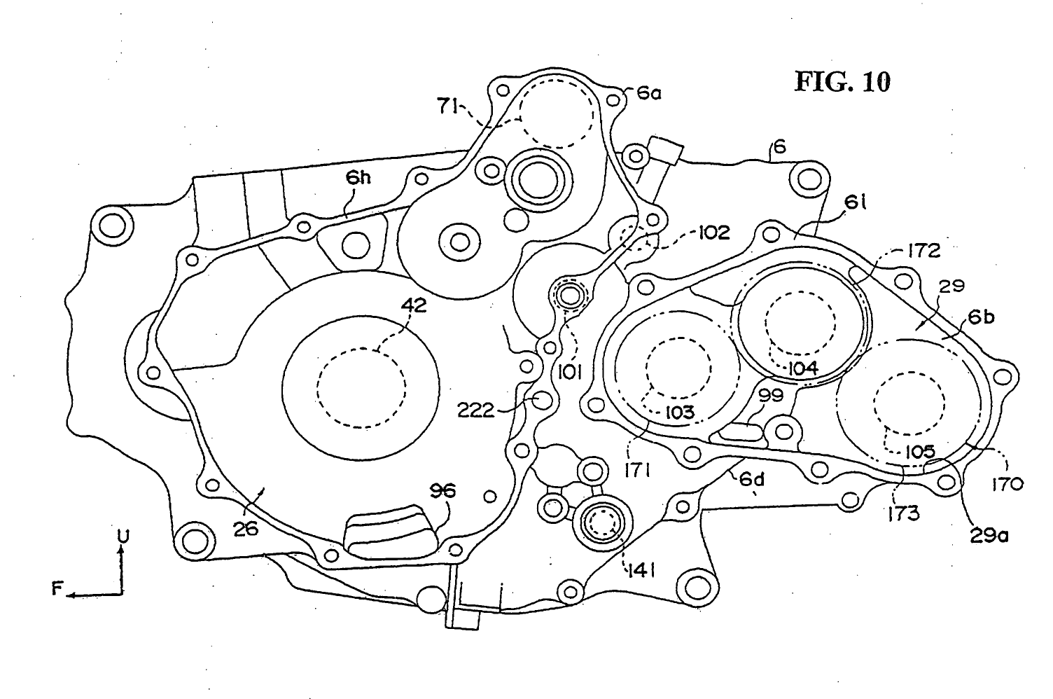

The right cover 9 is fastened to a cover mounting rib 5h formed to project from the right side surface of the right case 5 as shown in FIG. 7, and the left cover 10 is fastened to a cover mounting rib 6h formed to project from the left side surface of the left case 6 as shown in FIG. 10. In addition, the gear case 11 is fastened to a gear case mounting rib 6i formed to project from a rear portion of the left side surface of the left case 6.

A lubricating system for the power unit P will now be described below referring to FIGS. 2 to 14. The lubricating system includes the strainer 85 (see FIGS. 6, 12 and 14) provided in the inside of the oil reservoir chamber 35, the feed pump 81 (see FIGS. 2 and 11) by which the lubricating oil reserved in the oil reservoir chamber 35 is discharged to portions of the power unit P which need lubrication, and the scavenging pump 82 (see FIGS. 2, 11 and 14) by which the lubricating oil reserved in the oil reservoir chamber 35 is sucked through the strainer 85 and is again returned into the oil reservoir chamber 35. In addition, lubricating oil passages for conducting the lubricating oil within the power unit P are formed in the inside of the housing H and in the inside of the shafts.

As shown in FIG. 2, both the feed pump 81 and the scavenging pump 82 are trochoid type oil pumps, and a pump drive shaft 83 for driving both the pumps 81, 82 and rotors of both the pumps 81, 82 are contained in the right cover 5. The pump drive shaft 83 is screw-engaged with the right end of the crankshaft 42, and is rotated as one body with the crankshaft 42. The feed pump 81 is provided on the right side relative to the scavenging pump 82, and a pump cover 17 is mounted so as to cover the right side of the rotor of the feed pump 81. A suction port 81a of the feed pump 81 is formed in the inside of the right cover 9, and a discharge port 81b is formed in the inside of the pump cover 17. The scavenging pump 82 has a suction port 82a and a discharge port 82b both of which are formed in the inside of the right cover 9.

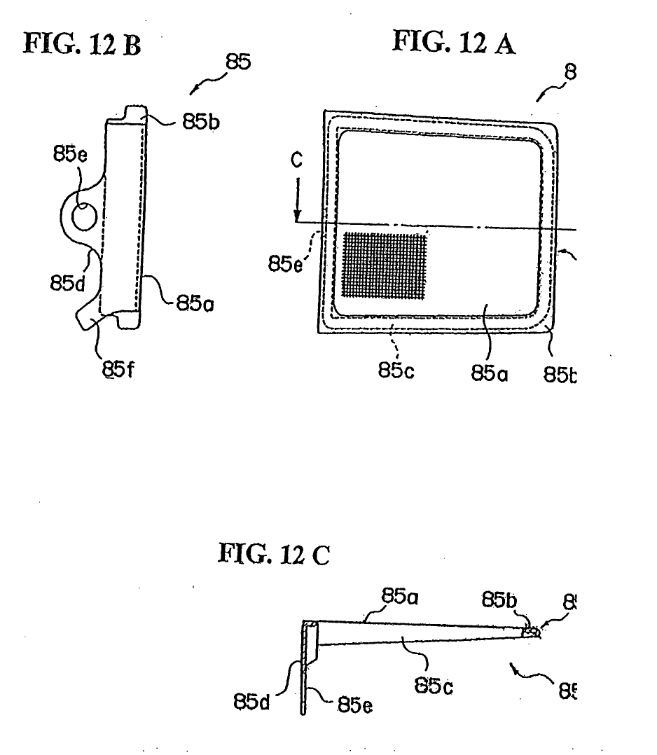

As shown in FIG. 12, the strainer 85 consists of a substantially rectangular sheet-formed filter element 85a composed of a metal mesh, a core 85b formed in a substantially rectangular frame-like shape from a metallic material and holding the filter element 85a, and a gasket 85c molded from a rubber material and interposed between the core 85b and the filter element 85a.

The core 85b is provided integrally with a flat plate-like mounting bracket 85d extending from one edge of the rectangular frame in a direction perpendicular to the plane in which the filter element 85a is held. A circular hole 85e is formed to penetrate a central upper portion of the mounting bracket 85d. In addition, as shown in FIG. 12(b), a lock part 85f, having a thickness equal to the plate thickness of the mounting bracket 85d, is formed to project diagonally outwards (in the direction opposite to the direction in which the element 85d is held) from an end portion of the mounting bracket 85d.

As shown in FIG. 6, the strainer 85 is inserted into a strainer accommodating hole 5r formed on the upper side of the lower wall portions 5f, 6f of the right case 5, from the right side by way of an edge denoted by symbol 85A in FIGS. 12(a) and 12(c), and is fitted in the accommodating hole 5r in the condition where the mounting bracket 85d, extending perpendicularly to the filter element 85a, abuts on an upper wall surface 5s of the accommodating hole 5r. The upper wall surface 5s is provided with a bolt inserting hole 5t opened to the right outer side of the right case 5. The strainer 85 is fixed to the right case 5 by screw-engaging a bolt with the bolt inserting hole 5t through the circular hole 85e in the mounting bracket 85d.

When the strainer 85 is fixed to the right case 5, the lock part 85f formed in the mounting bracket 85d projects upwards from the upper wall surface 5s, to face the shift change mechanism 140 and the reverse inhibitor mechanism 160. The lock part 85f and the right case 5 cooperate to lock one end portion 163b of the torsion coil spring 163 of the reverse inhibitor mechanism 160. Here, the one end portion 163b of the torsion coil spring 163 forms an extension portion 163f bent and extending rectilinearly. As shown in FIG. 6, a straight portion 163d of the extension portion 163f extends toward the lower front side relative to the inhibitor shaft 161, and has its tip portion abutting on the left side surface of the lock part 85f. A bent portion 163e (FIG. 5) of the extension portion 163f is so disposed as to bend and extend toward the left front upper side from the contact area of the straight portion 163d and the lock part 85f.

FIG. 6 shows the condition where a tip portion 162b of the inhibitor arm 162 is located within the inhibitor groove 142d. When a change lever is operated and the inhibitor arm 162 is rotated in the direction of arrow R2 together with the inhibitor shaft 161, the one end portion 163b of the torsion coil spring 163 is also swung simultaneously toward the rear upper side. Even when the one end portion 163b is swung in this manner, the one end portion 163d constantly maintains the condition in which the bent portion 163e is in contact with a side surface of the lock part 85f, since the bent portion 163e is so formed as to extend toward the front upper side from the contact area of the straight portion 163d and the lock part 85f before swinging. Therefore, the coil part 163a is compressed, without moving on the inhibitor shaft 161 in the axial direction.

Of the oil passages for conducting the lubricating oil, the lubricating oil passages formed in the main shaft 101, the reverse idle shaft 102 and the counter shaft 103 will now be described below, together with the support structures for the shafts 101 to 103, with reference to FIGS. 3 and 4.

As shown in FIG. 3, the main shaft 101 is provided with an axial oil passage 101c penetrating an axis central portion in the axial direction, and a plurality of radial oil passages 101d extending radially outwards from the axial oil passage 101c. A left end portion 101b of the main shaft 101 is supported by a bearing 181 contained in an accommodating hole 6p formed in a right side surface of the left case 6. In this case, the left end face of the main shaft 101 is substantially flush with the left end face of the bearing 181. In addition, the accommodating hole 6p is in the shape of a stepped hollow cylinder, with a diameter decreasing along the leftward direction. Therefore, when the bearing 181 is contained in the accommodating hole 6p and the main shaft 101 is supported thereby, an oil sump 219 communicating with the axial oil passage 101c is formed on the left side of the bearing 181.

As shown in FIG. 4, the reverse idle shaft 102 is provided with an axial oil passage 102c penetrating an axially central portion and extending in the axial direction, and a radial oil passage 102j which extends radially from the axial oil passage 102c. Further, a first jet oil passage 102f and a second jet oil passage 102g, extending radially from the axial oil passage 102c and being smaller in diameter than the radial oil passage 102d, are formed within the reverse idle shaft 102.

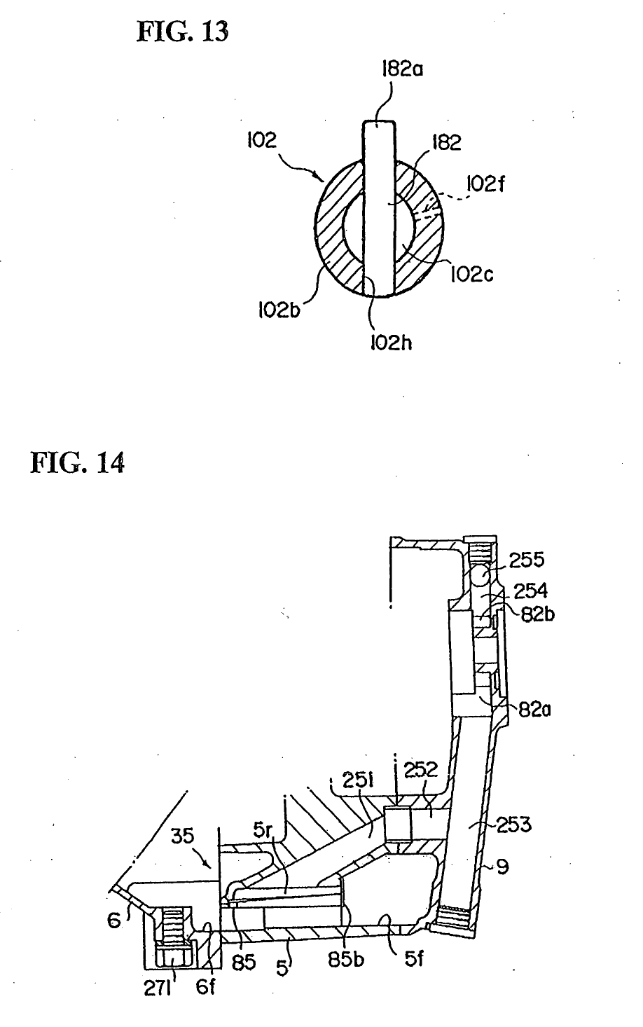

As shown in FIG. 13, a through-hole 102h, penetrating in a radial direction, is formed in a left end portion 102b of the reverse idle shaft 102, and a pin 182 is press fitted in the through-hole 102h. The pin 182, having a length greater than the diameter of the reverse idle shaft 102, is mounted with its tip portion 182a projecting from an opening on one side of the through-hole 102h. The diameter of the through-hole 102h and the pin 182 is sufficiently smaller than the diameter of the axial oil passage 102c to permit free flow of lubricating oil about the pin 182 through the axial oil passage 102c.

The reverse idle shaft 102 has its right end portion 102a press fitted in a hole provided in the left side surface of the right case 5, and has its left end portion 102b press fitted in a hole formed in the right side surface of the left case 6. This ensures that the axial oil passage 102c communicates with an oil sump 227 formed in the hole in which the right end portion 102a is press fitted through a right end opening 102d. In addition, the axial oil passage 102c communicates with an oil sump 226 formed in the hole in which the left end portion 102b is press fitted through a left end opening 102e. The right side surface of the left case 6 is provided with a lock groove 6q extending radially outwards from the hole in which the left end portion 102b of the reverse idle shaft 102 is press fitted. When the left end portion 102b of the reverse idle shaft 102 is press fitted into the hole in the left case 6, the tip portion 182a of the pin 182 is fitted into the lock groove 6q.

This ensures that the reverse idle shaft 102 is mounted while being positioned in the circumferential direction relative to the transmission case 8, the first jet oil passage 102f is opposed to a meshing area of the 5th speed gear train G5, and the second jet oil passage 102g is opposed to a meshing area of the 4th speed gear train G4. Since the reverse idle shaft 102 is disposed between the main shaft 101 and the counter shaft 103 in the front-rear direction and above both the shafts 101 and 103, the openings of the first and second jet oil passages 102f and 102g are directed substantially downwards.

The through-hole 102h is accurately formed to be circular in section by cutting or boring, and the pin 182 is also formed with high dimensional accuracy, whereby the pin 182 is press fitted in the through-hole 102h without chattering, and the chattering between the pin 182 and the lock groove 6q is reduced. Since the pin 182 is fitted in the lock groove 6q, the orientation of the reverse idle shaft 102 is fixed relative to the case 8, the positioning in the circumferential direction and the positioning in the axial direction of the reverse idle shaft 102 relative to the transmission case 8 can be made with high accuracy, and the directions of the openings of the first and second jet oil passages 102f and 102g can be set in the desired direction.

As shown in FIG. 3, the counter shaft 103 is provided with an axial oil passage 103c extending through an axially central portion and extending in the axial direction from the right end. The axial oil passage 103c is closed at a left portion thereof. A plurality of radial oil passages 103d, extending radially from the axial oil passage 103c, are provided. In the assembled condition, of the plurality of radial oil passages 103d, the radial oil passage 103f located on the most left side opens into the inside of the final gear chamber 29 as shown in FIG. 2, and, hence, it will be referred to also as “the final gear chamber supply oil passage 103f”.

A right end portion 103a of the counter shaft 103 is supported by a bearing 183 contained in an accommodating hole 5p formed in the right case 5. In this instance, the right end face of the counter shaft 103 is substantially flush with the right end face of the bearing 183. In addition, the accommodating hole 5p is in the shape of a stepped hollow cylinder, with the diameter decreased along the rightward direction. This ensures that when the bearing 183 is contained in the accommodating hole 5p and the counter shaft 103 is supported thereby, an oil sump 229, communicating with the axial oil passage 103c through a right end opening 103e, is formed on the right side of the bearing 183, in the inside of the accommodating hole 5p.

It is to be noted that the fork shaft 146 shown in FIG. 4 is a fixed shaft that is press fitted in a hole formed inside of the transmission case 8. However, the oil sump 221 is provided when the left end face of the fork shaft 146 is press fitted in a hole which is provided in the right face of the left case 6.

Lubricating oil passages formed in the inside of the housing H will now be described. As shown in FIG. 7, the right case 5 is provided therein with an oil passage 201 extending from the outer rear side of a lower portion of the cover mounting rib 5h toward the inner front side, and an oil passage 202 is formed which extends rightward through the inside of the cover mounting rib 5h from the oil passage 201 and which opens in the mating surface with the right cover 9. A pipe connected to the oil reservoir chamber 35 is connected to an outer opening of the oil passage 201. On the other hand, as shown in FIG. 11, the right cover 9 is provided with an oil passage 203 extending in the left-right direction and opened in the mating surface with the right case 5, and, when the right cover 9 is connected to the right case 5, the openings of the oil passages 202 and 203 are mated with each other. The oil passage 203 communicates with an oil passage 205 extending vertically through the right cover 9, and the upper end of the oil passage 205 communicates with the suction port 81a of the feed pump 81. The discharge port of the feed pump 81 is connected to an oil filter 210 through an oil passage inside the pump cover 17. An outlet port 210b of the oil filter 210 communicates with an oil passage 211 extending through the right cover 9, and the front upper end of the oil passage 211 communicates with an oil passage 212 extending further toward the front upper side.

The front upper end of the oil passage 212 communicates with an oil passage 213 (FIG. 7) extending through the right case 5 in the left-right direction. The oil passage 213 communicates with a bolt inserting hole formed in the peripheral edge of a fitting hole 4a for the purpose of connecting the cylinder block 3 to the crankcase 4, and the front end of an oil passage 214 (FIG. 4), extending through the right case 5 in the front-rear direction along the upper wall portion 5e, communicates therewith. An oil passage 215, extending in the left-right direction is formed at a rear end portion of the oil passage 214.

As shown in FIG. 8, the oil passage 215 opens in the mating surface of the right case 5 with the left case 6 at the upper wall portion 5e. As shown in FIG. 9, the left case 6 is provided therein with an oil passage 216 which extends in the left-right direction and which is opened in the mating surface with the right case 5 at the upper wall portion 6e. When the right case 5 and the left case 6 are coupled, the openings of the oil passages 215 and 216 are mated with each other, as shown in FIG. 4.

As shown in FIGS. 4 and 9, an oil passage 218 extends through a left side portion of the left case 6 toward the front lower side, and communicates with the oil passage 216. The oil passage 218 also communicates with an oil sump 226 formed in the hole in which the left end portion 102b of the reverse idle shaft 102 is press fitted, and the oil passage 218 further also communicates with an oil sump 219 formed inside the accommodating hole 6p in which the bearing 181 for bearing the left end portion 101b of the main shaft 101 is mounted. In addition, an oil passage 220 is formed which extends, on an extension line of the oil passage 218, from the oil sump 219 for the main shaft 101. The front lower end of the oil passage 220 communicates with an oil sump 221 formed in the hole in which the left end portion 146b of the fork shaft 146 is press fitted.

As shown in FIGS. 4, 9 and 10, an oil passage 222 extends through the cover mounting rib 6h of the left case 6 in the left-right direction, opens in the mating surface with the left cover 10, and communicates with the oil sump 221.

As shown in FIG. 4, the left cover 10 is provided therein with an oil passage 223 which extends in the left-right direction and opens in the mating surface with the left case 6, and, when the left case 6 and the left cover 10 are connected to each other, the openings of the oil passages 222 and 223 are mated with each other. As shown in FIGS. 2 and 4, an oil passage 225, which opens into the left accessory chamber 26, communicates with the oil passage 223.

In addition, as shown in FIGS. 3 and 4, the oil sump 219 communicates with the axial oil passage 101c in the main shaft 101. The right end opening of the axial oil passage 101c is closed. An oil sump 226 communicates with the axial oil passage 102c in the reverse idle shaft 102 through the left end opening 102e. In addition, the axial oil passage 102c communicates with an oil sump 227, formed in the hole in which the right end portion 102a is press fitted, through the right end opening 102d. As shown in FIGS. 3 and 7, an oil passage 228, extending toward the rear lower side of the transmission chamber 28, communicates with the oil sump 227. The oil sump 228 also communicates with an oil sump 229 formed in the inside of the accommodating hole 5p in which the bearing 183 for bearing the right end portion 103a of the counter shaft 103 is mounted. The oil sump 229 communicates with the axial oil passage 103c in the counter shaft 103 through the right end opening 103e.

As shown in FIGS. 6 and 14, the right case 5 is provided therein with an oil passage 251 extending toward the right upper side from the accommodating hole 5r in which the strainer 85 is contained. The right cover 9 is provided therein with an oil passage 252 extending in the left-right direction, and, when the right case 5 and the right cover 9 are connected to each other, the openings of the oil passages 251 and 252 are mated with each other. As shown in FIGS. 11 and 14, the oil passage 252 communicates with an oil passage 253 which extends vertically through the right cover 9. The upper end portion of the oil passage 253 communicates with the suction port 82a of the scavenging pump 82. The discharge port 82b of the scavenging pump 82 communicates with an oil passage 254, which extends rearwards through the right cover 9. As shown in FIG. 11, the right cover 9 is provided therein with an oil passage 255 extending vertically through a rear portion thereof and communicating with the oil passage 254. The right cover 9 is further provided with an oil passage 256 extending rearwards from the oil passage 255. A pipe connected to the oil reservoir chamber 35 is connected to a rear end opening of the oil passage 256. In addition, as shown in FIG. 14, a drain bolt 271 is screw-engaged with a lower wall portion 6f of the left case 6, and the lubricating oil reserved in the oil reservoir chamber 35 can be drained by detaching the drain bolt 271.

In the power unit P having the lubricating oil passages described above, when the engine E is started and the crankshaft 42 is rotated, the pump drive shaft 83 is rotated, and the rotors of the feed pump 81 and the scavenging pump 82 are driven to rotate. When the feed pump 81 is operated, the lubricating oil reserved in the oil reservoir chamber 35 flows into the oil passage 201, is sucked into the suction port 81a of the feed pump 81, and is discharged from the discharge port 81b. The lubricating oil from the discharge port 81b is filtered by the oil filter 210, is led from the inside of the right cover 9 into the inside of the right case 5 through the oil passage 212, is led through the oil passages 215 and 216 into the inside of the left case 6, and is supplied into the oil passage 218. The lubricating oil supplied into the oil passage 218 is supplied via the oil sump 226 into the axial oil passage 102c in the reverse idle shaft 102, is supplied also via the oil sump 219 into the axial oil passage 101c in the main shaft 101, and is supplied into the oil passage 220.

As shown in FIG. 3, the lubricating oil supplied into the axial oil passage 102c in the reverse idle shaft 102 is supplied via the radial oil passage 102j to a joining area of the reverse idle gear 132 and the reverse idle shaft 102; in addition, as shown in FIG. 8 also, it is jetted to the meshing area of the 5th speed drive gear 125 and the 5th speed driven gear 130 through the first jet oil passage 102f, and is jetted to the meshing area of the 4th speed drive gear 124 and the 4th speed driven gear 129 through the second jet oil passage 102g. The lubricating oil thus supplied to the joining area and the meshing areas is discharged into the inside of the transmission chamber 28.

In addition, the lubricating oil provided in the axial oil passage 102c in the reverse idle shaft 102 is supplied via the oil sump 227 into the oil passage 228, and is supplied via the oil sump 229 into the axial oil passage 103c in the counter shaft 103. The lubricating oil thus supplied into the axial oil passage 103c in the counter shaft 103 is supplied via the radial oil passages 103d to the joining areas between the 1 st speed driven gear 126, the reverse driven gear 133, the 3rd speed driven gear 128, the third shift sleeve 138, the 5th speed driven gear 130 and the 2nd speed driven gear 127, and the counter shaft 103. The lubricating oil supplied to these joining areas is discharged into the inside of the transmission chamber 28.

Further, as shown in FIG. 2, the lubricating oil supplied into the axial oil passage 103c in the counter shaft 103 is discharged in the inside of the final gear chamber 29 via the final gear supply oil passage 103f formed at the left end portion 103b.

As shown in FIG. 3, the lubricating oil supplied into the axial oil passage 101c in the main shaft 101 is supplied via the radial oil passages 101d to the joining areas of the primary driven gear 112, the 4th speed drive gear 124, the 5th speed drive gear 125 and the first shift sleeve 136, and the main shaft 101. The lubricating oil supplied to these joining areas is discharged into the inside of the transmission chamber 28.

As shown in FIGS. 2 and 4, the lubricating oil supplied into the oil passage 220 is directed through the inside of the left case 6 into the inside of the left cover 10, and is discharged via the oil passage 225 into the inside of the left accessory chamber 26. Further, a portion of the lubricating oil discharged from the feed pump 81 is directed through the pipe 84 into an oil passage 267 formed in the inside of the crankshaft. The lubricating oil thus directed into the oil passage 267 is supplied to a pivotal connecting area between the crank pin 42d and the connecting rod 44, and is discharged into the inside of the crank chamber 24.

The lubricating oil discharged into the crank chamber 24 is returned into the oil reservoir chamber 35 via the communicating space 4b located at a front lower portion of the crank chamber 24. In this case, the lubricating oil discharged into the crank chamber 24 is raked out in the circumferential direction due to the rotation of the crank webs 42c, 42c. Oil collecting ribs 5j, 6j are formed at lower end portions of the central partition walls 5g, 6g so that the lubricating oil raked out by the crank webs 42c, 42c and splashed in the circumferential direction is collected, and the lubricating oil thus collected is efficiently returned into the oil reservoir chamber 35 via the communicating space 4b.

The lubricating oil discharged into the left accessory chamber 26 is returned into the oil reservoir chamber 35 via a first communicating port 96 formed at a side lower portion of the left case 6 so as to establish communication between a lower portion of the left accessory chamber 26 and the oil reservoir chamber 35, as shown in FIGS. 9 and 10. The lubricating oil discharged into the transmission chamber 28 flows directly into the oil reservoir chamber 35 located on the lower side.

Meanwhile, the lubricating oil discharged via the final gear supply oil passage 103f into the final gear chamber 29 is jettedly supplied to the final drive gear 171 and the final idle gear 172. A rear lower portion 29a of the inside of the final gear chamber 29 is hollowed down along the outline of the final driven gear 173. A portion of the lubricating oil discharged into the final gear chamber 29 reaches the hollow at the rear lower portion 29a, and is raked up by the final driven gear 173, to lubricate the final gear train 170.

As shown in FIGS. 9 and 10, a second communicating port 99 for establishing communication between a central lower portion in the front-rear direction of the final gear chamber 29 (i.e., the lower side of the final idle shaft 104) and a rear portion of the transmission chamber 28 is formed at a side rear portion of the left case 6. Much of the lubricating oil discharged into the final gear chamber 29 collects in a bottom portion of the final gear chamber 29, and is returned into the transmission chamber 28 via the second communicating port 99. The second communicating port 99 is formed at a position close to a rear wall portion 6d of the left case 6 and close to a lower wall portion of the case mounting rib 6i, and is adjacent to the bottom wall of the final gear chamber 29. In addition, the rear wall portion 6d of the left case 6 extends so as to be inclined forwards, along the direction toward the oil reservoir chamber 35 on the lower side, together with a rear wall portion 5d of the right case 5. Therefore, the lubricating oil discharged from the final gear chamber 29 into the transmission chamber 28 via the second communicating port 99 flows down inside the transmission chamber 28 along the rear wall portions 5d, 6d, to be directed into the oil reservoir chamber 35.

Thus, in this embodiment, the reverse idle shaft 102, which forms a part of the transmission M, is provided therein with the axial oil passage 102c and the first and second jet oil passages 102f and 102g. Both end portions of the reverse idle shaft 102 are supported by the bisected type transmission case 8, the axial oil passage 102c communicates with the oil passages 218 and 228 (the oil sumps 226 and 227) formed in the inside of the right case 5 and the left case 6, and the openings of the first and second jet oil passages 101f and 102g are opposed to the meshing areas of the 4th speed gear train G4 and the 5th speed gear trains G5, of the forward speed setting gear trains, provided between the main shaft 101 and the counter shaft 103.

This configuration ensures that the lubricating oil is jetted from the reverse idle shaft 102 to the meshing areas of the gear trains that constitute the transmission M, whereby the speed change gear trains are effectively lubricated. In addition, the members which form the oil passages for directing the lubricating oil from the oil passage in the case half on one side into the oil passage in the case half on the other side and which form the oil passages for jetting the lubricating oil toward the speed change gear train are shafts in the transmission M, so that the transmission M and the lubricating system having the above-mentioned effects can be configured while reducing the number of component parts.

In addition, the pin 182, which includes its tip portion 182a which projects radially outward, is provided at an end portion of the reverse idle shaft 102, and, at the time of fixing the reverse idle shaft 102 to the transmission case 8, the tip portion 182a of the pin 182 is fitted into the lock groove 6q formed in the inside surface of the transmission case 8, whereby rotation of the reverse idle shaft 102 can be restrained with the simple structure. In addition, by this fitting, the reverse idle shaft 102 can be positioned in the circumferential direction relative to the transmission case 8. Therefore, the openings of the first and second jet oil passages 102f and 102g can be securely set to aim in the desired direction.

In addition, the left end opening 102e of the axial oil passage 102c in the reverse idle shaft 102 communicates with the oil passage 218 (and the oil sump 226) connected to the discharge port 81b of the feed pump 81, and the right end opening 102d of the reverse idle shaft 102 communicates with the oil passage 228 (and the oil sump 227) connected to the right end opening 103e of the axial oil passage 103c in the counter shaft 103, whereby it is ensured that the axial oil passage 102c in the reverse idle shaft 102 is located on the upstream side, while the axial oil passage 103c in the counter shaft 103 is located on the downstream side. As a result of this configuration, the lubricating oil at a higher pressure can be jetted toward the meshing areas of the speed change gear trains, and the lubricating oil lowered in pressure through the jetting or spraying is supplied to the gears provided on the counter shaft 103, etc. Thus, the supply of the lubricating oil according to the oil pressure is effectively achieved.

As shown in FIG. 8, since the reverse idle shaft 102, extending in the left-right direction, is disposed between the main shaft 101 and the counter shaft 103 in the front-rear direction and above both the shafts 101 and 103, the meshing areas of the 1st to 5th speed gear trains G1 to G5 for setting the forward speed stages, of the speed change gear trains, are located on the lower side of the reverse idle shaft 102. Therefore, the first and second jet oil passages 102f and 102g extend substantially downward from the axial oil passage 102c. This shaft layout ensures that the lubricating oil can be vigorously jetted downwards from the first and second jet oil passages 102f and 102g, and the speed change gear trans can be lubricated effectively.

Furthermore, the counter shaft 103 and the output shaft 105 are arranged in a front-rear relationship, and the final idle shaft 104 is disposed between both the shafts 103 and 105 in the front-rear direction and above both the shafts 103, 105. Moreover, in this embodiment, the counter shaft 103 and the output shaft 105 are provided above the crankshaft 42, and the oil reservoir chamber 35 is located on the lower side of the crank chamber 24 in which the crankshaft 42 is contained. Therefore, the height difference from the second communicating port 99, for establishing communication between the final gear chamber 29 and the transmission chamber 28, to the oil reservoir chamber 35 is made large, so that the lubricating oil discharged into the final gear chamber 29 can be swiftly discharged to the side of the oil reservoir chamber 35, and the possibility of the lubricating oil being returned from the oil reservoir chamber 35 side to the final gear chamber 29 side is lowered. In addition, this layout ensures that the amount of the lubricating oil reserved in the oil reservoir chamber 35 is reduced, whereby a reduction in the stirring resistance of the final gear train 170 can be contrived, and the amount of the lubricating oil in the oil reservoir chamber 5 is stabilized, whereby such troubles as entrapment of air into the feed pump 81 can be obviated. In addition, since the second communicating port 99 is provided at a central portion in the front-rear direction of the final gear chamber 29, the vertical position of the second communicating port 99 in relation to the oil level is stabilized, so that the lubricating oil can be easily discharged via the second communicating port 99 even if the oil level of the lubricating oil in the final gear chamber 29 is inclined to the front or rear side due to vehicle operation on a slope or in similar situations.

The lubricating oil discharged into the final gear chamber 29 is not discharged therefrom, but collects in a bottom portion, at least up to the height at which the second communicating port 99 is formed. In this embodiment, the second communicating port 99 is close to a lower wall portion of the gear case mounting rib 6i, so that the amount of the lubricating oil collecting at minimum in the final gear chamber 29 can itself be reduced, and stabilization of the amount of the lubricating oil in the oil reservoir chamber 35 is obtained.

In addition, the second communicating port 99 is formed close to the inside surface of the rear wall portion 6d of the left case 6 extending while being inclined to the front side along the direction from the transmission chamber 28 toward the oil reservoir chamber 35 on the lower side, whereby the lubricating oil discharged into the transmission chamber 28 via the second communicating port 99 can be directed along the inside surface of the rear wall portion 6d, to be returned into the oil reserving chamber 35. Therefore, notwithstanding the large height difference secured between the second communicating port 99 and the oil reservoir chamber 35, the situation in which the lubricating oil discharged into the transmission chamber 28 drops directly into the oil reservoir chamber 35 to bubble the lubricating oil reserved in the oil reservoir chamber 35 is obviated, and the possibility of entrapment of air into the feed pump 81 is further lowered.

When the gear case 11 is detached, the final gear train 170 is exposed to the vehicle left side together with the second communicating port 99, while the right end portions of the counter shaft 103, the final idle shaft 104 and the output shaft 105 are kept held on the left case 6 side. Therefore, the final gear train 170 can be easily replaced by dismounting and mounting operations, so that the maintenance of the final gear train 170 and customizing such as changing the reduction gear ratio of the transmission M can be easily carried out. In addition, the maintenance of the surroundings of the second communicating port 99 can also be easily conducted.

Furthermore, the strainer 85 is mounted by fitting it into the accommodating groove 5r formed in the right case 5, and is then fastened to the right case 5. Therefore, the strainer 85 is prevented from slipping off easily, and the mounting of the strainer 85 in position is facilitated. Besides, one end portion 163b of the torsion coil spring 163 constituting the reverse inhibitor mechanism 160 is locked on the projected portion 85f formed as one body with the mounting bracket 84d of the strainer 85 assuredly fixed in this manner. With the strainer 85 thus assuredly fixed, the torsion coil spring 163 is also assuredly supported. In addition, the need for forming a rib and/or a groove for locking the torsion coil spring on the inside surface of the housing H as in the prior art is eliminated, whereby manufacturability of the housing H is enhanced.

In addition, the one end portion 163b of the torsion coil spring 163 is formed to have the straight portion 163d extending from the coil portion 163a, and the bent portion 163e bent at the tip of the straight portion 163d. This ensures that even where the lock part 85f of the mounting bracket 85d is formed in a flat plate-like shape, the one end portion 163b of the torsion coil spring 163 can always be maintained in abutment on the lock part 85f, the mounting bracket 85d is easily formed, and the manufacturability of the strainer 85 is enhanced. Further, where the lock part 85f is formed to project in the direction of going away from the element 85a, the bent portion 163e of the torsion coil spring 163 or the like component can be mounted in position without interfering with the strainer side, and the reverse inhibitor mechanism 160 can be operated smoothly.

In order to obtain a reduction in the size of the reverse inhibitor mechanism 160 configured by locking the torsion coil spring 163 on the strainer 85, it is necessary to set the shift drum 142 and other component members of the shift change mechanism 140 closer to the vicinity of the oil reservoir chamber 35. Here, the shift change mechanism 140 is a mechanism for changing the setting of the speed change stage, and does not form the transmission line. Therefore, placement of the shift change mechanism 140 closer to the oil reservoir chamber 35 does not produce any influence on the power transmission efficiency, and it is thereby possible to configure the reverse inhibitor mechanism 160 in a reduced size.

In addition, the strainer 85 is mounted by inserting it from the right side into the accommodating hole formed in the right case 5, and is fastened to the right case 5 through the bolt inserted in the bolt inserting hole 5t opened in the right side surface of the right case 5, so that it is covered by the right cover 9 in the mounted condition. Therefore, the strainer 85 can be easily replaced through dismounting and mounting operations by only detaching the right cover 9, so that maintenance of the strainer 85 is easily conducted.

While a working example of the present invention has been described above, the present invention is not limited to the working example described above, but various design alterations may be carried out without departing from the present invention as set forth in the claims.

What is claimed is:

1. A lubricating system for a vehicle power unit, the power unit comprising a power unit case, an internal combustion engine housed in the power unit case, and a transmission housed in the power unit case, wherein
the lubricating system includes a feed pump provided in the vehicle power unit and driven by the internal combustion engine,
the power unit case includes a first case half and a second case half coupled to each other,
the transmission operates to transmit a rotational driving force of the internal combustion engine at a modified speed to an output shaft, and the transmission is supplied with a lubricating oil discharged from the feed pump, through an oil passage formed in the power unit case, the transmission comprising:
an input shaft rotatably supported on the power unit case, coaxially supporting input-side gears, and being supplied with the rotational driving force of the internal combustion engine;
the output shaft rotatably supported on the power unit case, coaxially supporting output-side gears meshed with the input-side gears, and outputting a rotational driving force from the power unit; and
an intermediate shaft supported, in the state of being restricted in rotation, on the power unit case at a position adjacent to the input shaft and the output shaft, and coaxially supporting an idle gear,
wherein the intermediate shaft comprises
a first end, and
a second end opposed to the first end,
and wherein the lubricating system further comprises
an axially aligned axial oil passage formed in the intermediate shaft so as to extend between the first and second ends of the intermediate shaft, and
a radial oil passage formed in the intermediate shaft so as to extend radially outwards from the axial oil passage and to open in an outer peripheral surface of the intermediate shaft,
such that communication is provided between the first and second ends of the intermediate shaft and the radial oil passage, between the first end of the axial oil passage and a first oil passage formed in the first case half, and between the second end of the axial oil passage and a second oil passage formed in the second case half.

2. The lubricating system for a vehicle power unit as set forth in claim 1, wherein
said intermediate shaft further comprises:
a hole extending in a radial direction, and
an anti-rotation member, the anti-rotation member fitted in said hole and projecting radially outwards therefrom,
said power unit case comprises a lock groove formed in an inside wall surface thereof, and
said anti-rotation member is fitted in the lock groove when said intermediate shaft is supported on said power unit case.

3. The lubricating system for a vehicle power unit as set forth in claim 1, wherein
said idle gear on said intermediate shaft is a reverse idle gear meshed with said input-side gear and said output-side gear, and
said intermediate shaft is disposed above said input shaft and said output shaft when the vehicle power unit is mounted on a vehicle.

4. The lubricating system for a vehicle power unit as set forth in claim 1, wherein
said output shaft is rotatably supported on said first case half at one end thereof, is rotatably supported on said second case half at the other end thereof, and is provided with an oil passage extending in the axial direction from said other end;
said first oil passage permits communication between a discharge port of said feed pump and said axial oil passage; and
said second oil passage communicates with said other end of said output shaft

5. The lubricating system for a vehicle power unit as set forth in claim 1, wherein
said radial oil passage in said intermediate shaft is disposed at a location opposed to the meshing part of said input-side gear and said output-side gear.

6. The lubricating system for a vehicle power unit as set forth in claim 1, wherein
said radial oil passage in said intermediate shaft is disposed at a location opposed to the meshing part of said input-side gear and said output-side gear, and is oriented such that the opening of the radial oil passage in the outer peripheral surface of the intermediate shaft faces the meshing part of said input-side gear and said output-side gear.

7. The lubricating system for a vehicle power unit as set forth in claim 1, wherein
said intermediate shaft further comprises:
a first jet oil passage and a second jet oil passage, the first and second oil jet passages extending radially from the axial oil passage, the first and second oil jet passages being smaller in diameter than the radial oil passage.

8. The lubricating system for a vehicle power unit as set forth in claim 1, wherein said power unit case further comprises a first hole provided said first case half, and a second hole provided in said second case half, and
wherein the first end of intermediate shaft is press fitted in the first hole, and the second end of the intermediate shaft is press fitted in the second hole.

9. The lubricating system for a vehicle power unit as set forth in claim 1, wherein said power unit case further comprises:
a first hole provided said first case half, the first hole comprising a first oil sump formed therein, and
a second hole provided in said second case half, the second hole comprising a second oil sump formed therein,
wherein the first end of intermediate shaft is press fitted in the first hole such that the axial oil passage communicates with the first oil sump, and the second end of the intermediate shaft is press fitted in the second hole such that the axial oil passage communicates with the second oil sump.

10. The lubricating system for a vehicle power unit as set forth in claim 1, wherein the main shaft comprises:
a main shaft axial oil passage extending within the main shaft along an axis central portion in the axial direction, and
a plurality of main shaft radial oil passages extending radially outwards from the main shaft axial oil passage,
wherein a main shaft oil sump, which communicates with the main shaft axial oil passage, is formed in the power unit case at one end of the main shaft.

11. The lubricating system for a vehicle power unit as set forth in claim 1, wherein
said intermediate shaft further comprises:
a through-hole extending in a radial direction, and
a pin, the pin comprising a length greater than a diameter of said intermediate shaft, the pin fitted in said hole such that one end of said pin projects radially outwards therefrom,
said power unit case comprises a lock groove formed in an inside wall surface thereof, and
said anti-rotation member is fitted in the lock groove when said intermediate shaft is supported on said power unit case such that movement of the intermediate shaft relative to said power unit case is prevented.

12. A lubricating system for a power unit of a vehicle, the vehicle comprising a vehicle body and wheels, the vehicle being powered by the power unit mounted on the vehicle body, the power unit comprising a power unit case, an internal combustion engine housed in the power unit case, and a transmission housed in the power unit case, wherein
the power unit case includes a first case half and a second case half coupled together,
the lubricating system includes a feed pump provided in the vehicle power unit, the feed pump being driven by the internal combustion engine,
the transmission operates to transmit a rotational driving force of the internal combustion engine at a modified speed to the wheels, and the transmission is supplied with a lubricating oil discharged from the feed pump, through an oil passage formed in the power unit case, the transmission comprising:
an input shaft rotatably supported on the power unit case, coaxially supporting input-side gears, and being supplied with the rotational driving force of the internal combustion engine;
the output shaft rotatably supported on the power unit case, coaxially supporting output-side gears meshed with the input-side gears, and outputting a rotational driving force to the wheels; and
an intermediate shaft supported on the power unit case at a position adjacent to the input shaft and the output shaft, and coaxially supporting an idle gear, the intermediate shaft being fixed relative to the power unit case, the intermediate shaft comprising a first end, and a second end opposed to the first end,
wherein the lubricating system further comprises:
an axially aligned axial oil passage formed within the intermediate shaft so as to extending between the first and second ends of the intermediate shaft, and
a radial oil passage formed in the intermediate shaft so as to extend radially outwards from the axial oil passage and to open in an outer peripheral surface of the intermediate shaft,
such that communication is provided between the first and second ends of the intermediate shaft and the radial oil passage, between the first end of the axial oil passage and a first oil passage formed in the first case half, and between the second end of the axial oil passage and a second oil passage formed in the second case half.

13. A vehicle transmission lubricating system which lubricates a vehicle transmission, the transmission operating to receive an externally applied rotational driving force and transmit the rotational driving force at a modified speed to an output shaft, wherein the transmission comprises:
the transmission lubricating system;
a transmission case, the transmission case comprising a first case half and a second case half coupled to each other;
an input shaft rotatably supported on the transmission case, coaxially supporting input-side gears, and receiving the externally applied rotational driving force;
the output shaft rotatably supported on the transmission case, coaxially supporting output-side gears meshed with the input-side gears, and outputting a modified rotational driving force from the transmission; and
an intermediate shaft supported, in the state of being restricted in rotation, on the transmission case at a position adjacent to the input shaft and the output shaft, and coaxially supporting an idle gear,
wherein the intermediate shaft comprises
a first end, and
a second end opposed to the first end,
and wherein the transmission lubricating system comprises
an axially aligned axial oil passage formed within the intermediate shaft so as to extend between the first and second ends of the intermediate shaft, and
a radial oil passage formed in the intermediate shaft so as to extend radially outwards from the axial oil passage and to open in an outer peripheral surface of the intermediate shaft,
such that communication is provided between the first and second ends of the intermediate shaft and the radial oil passage, between the first end of the axial oil passage and a first oil passage formed in the first case half, and between the second end of the axial oil passage and a second oil passage formed in the second case half.
